(19) United States
(12) Patent Application Publication
(10) Pub. No.: US 2011/0022456 A1
(43) Pub. Date: Jan. 27, 2011

(54) MOBILE PHONE EQUIPPED WITH BAR CODE READER AND RELATED METHOD

(76) Inventors: Conrad R. Carney, II, Lexington, KY (US); James H. Johnson, JR., Lexington, KY (US)

Correspondence Address: KING & SCHICKLI, PLLC, 247 NORTH BROADWAY, LEXINGTON, KY, 40507, US

(21) Appl. No.: 12/841,373

(22) Filed: Jul. 22, 2010

Related U.S. Application Data
(60) Provisional application No. 61/227,535, filed on Jul. 22, 2009.

(51) Int. Cl. G06Q 30/00; G06K 19/06

(52) U.S. Cl. 705/14.38; 705/14.39; 235/494

(57) ABSTRACT

A communication device comprises a transmitter, a receiver and a bar code reader. In one embodiment the communication device comprises a combined or integrated mobile telephone and bar code reader. Further, a method is provided for promoting the sale of a selected good or service. The method comprises the steps of receiving a bar code for a selected good or service from the communication device of the consumer and sending a coupon for the selected good or service to the communication device of the consumer.

This application claims priority to U.S. Provisional Patent Application Ser. No. 61/227,535 filed 22 Jul. 2009, the entire disclosure of which is incorporated herein by reference.

### TECHNICAL FIELD AND INDUSTRIAL APPLICABILITY OF THE INVENTION

The present invention relates generally to the marketing field and, more particularly, to a combined mobile telephone and bar code reader as well as to a method of marketing utilizing mobile phone text messaging.

### BACKGROUND OF THE INVENTION

The marketing of goods and services by means of mobile phone text messaging is a rapidly growing field. The concept of narrow casting text messages to existing or potential business customers is known. Relevant prior art patents include U.S. Pat. No. 6,754,314 to Wengrovitz et al, U.S. Pat. No. 7,197,324 to Sweeney and U.S. Pat. No. 7,437,413 to Okuyama et al.

The present invention relates to a new and improved method of marketing using a mobile phone text messaging service.

### SUMMARY OF THE INVENTION

In accordance with the purposes of the present invention as described herein, a communication device is provided comprising a transmitter, a receiver and a bar code reader. More specifically, the communication device may comprise a combined mobile telephone and bar code reader.

In accordance with an additional aspect of the present invention a method is provided for promoting the sale of a selected good or service. The method comprises the steps of receiving a bar code for a selected good or service from a communication device of the consumer and sending a coupon for the selected good or service to the communication device of the consumer.

More specifically describing the invention, the method includes the step of determining the current availability for the selected good or service identified by the bar code. Further, the method includes immediately sending a coupon for the selected good or service to the communication device of the consumer when the coupon is currently available. Further, the method includes storing the interest of the consumer in the selected good or service in a memory storage device and sending a coupon for the selected good or service to the communication device of the consumer at some future time when such a coupon is available. Further, the method includes redeeming the coupon.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical block diagram of the communication device of the present invention; and

FIG. 2 is a schematical block diagram of the method of the present invention.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

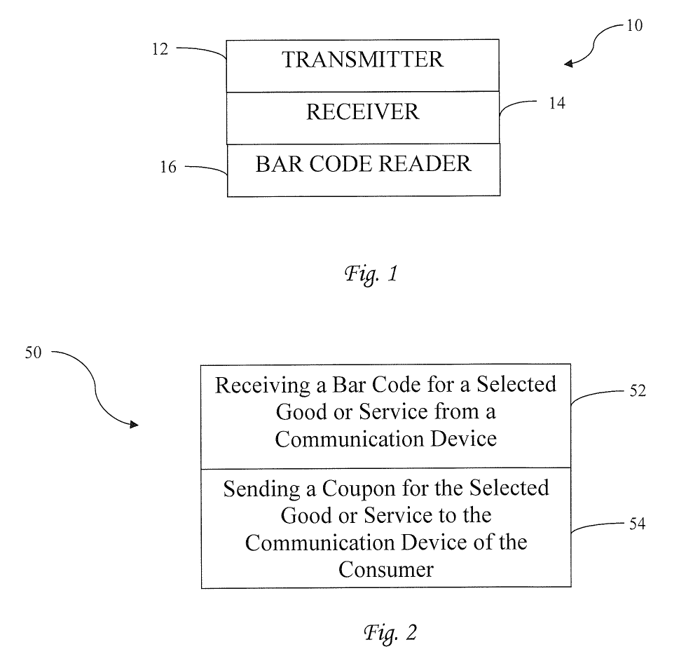

Reference is now made to FIG. 1 schematically illustrating the communication device 10 of the present invention. As illustrated the communication device 10 includes a transmitter 12, a receiver 14 and a bar code reader 16. The transmitter 12 and receiver 14 may take the form of a mobile telephone such as is well known in the art. Thus, the communication device 10 may comprise an integrated mobile telephone and bar code reader.

The device 10 of the present invention is particularly useful in the method of the present invention illustrated in FIG. 2. Specifically, the method 50 may be broadly defined as comprising the steps of receiving a bar code for a selected good or service from a communication device 10 of a consumer (52) and sending a coupon for the selected good or service to the communication device of the consumer (54).

Still further describing the invention, the method may also include the step of determining the current availability of a coupon for the selected good or service. Thus, the method may include immediately sending a coupon for the selected good or service to the communication device 10 of the consumer when the coupon is currently available. In contrast, when the coupon is not currently available the method includes storing the interest of the consumer in the selected good or service in a memory storage device and subsequently sending the coupon for the selected good or service to the communication device 10 of the consumer at some future time when an appropriate coupon becomes available. Still further, the method may include periodically sending to the consumer a discount coupon for the selected good. For example, a coupon for a particular brand of laundry detergent could be sent to the consumer once a month when the consumer selects that consumer product as one of interest. In any circumstance the method also includes redeeming the coupon when purchasing the selected good or service.

The foregoing description of the preferred embodiments of the present invention have been presented for purposes of illustration and description. It is not intended to be exhaustive or to limit the invention to the precise form disclosed. Obvious modifications or variations are possible in light of the above teachings. While the device 10 is illustrated and described as comprising an integrated mobile telephone and bar code reader, it should be appreciated that the device can simply be a dedicated bar code reader and storage device without other state of the art mobile phone capabilities.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method of promoting sales at a specific retail store location, comprising:
providing a promotional website on the internet;
allowing a consumer to designate a specific retail store location on said website;
allowing a consumer to designate a specific good or service for purchase at said designated specific retail store location on said website; and
sending a coupon for purchase of said designated good or service at said designated specific retail store location.

2. The method of claim 1, wherein said coupon includes a bar code.

3. The method of claim 1, wherein said coupon is sent directly to a mobile phone of said consumer where said coupon is stored for future use.

4. The method of claim 3, including determining location of said consumer by monitoring location of mobile phone of said consumer and activating said mobile phone to send said coupon to said designated specific retail store location when said monitored location of said consumer matches location of said designated specific retail store location.

5. The method of claim 4, including redeeming said coupon when said consumer checks out at said designated specific retail store location.

6. The method of claim 1, wherein said coupon is sent directly to said point of sale system at said designated specific retail store location.

7. The method of claim 1, including redeeming said coupon when said consumer checks out at said designated specific retail store location.

8. The method of claim 7, including matching said coupon to said consumer by means of a code.
